(19) United States
(12) Patent Application Publication
(10) Pub. No.: US 2015/0348100 A1
(43) Pub. Date: Dec. 3, 2015

(54) SEARCH ENGINE SERVER THAT SEARCHES DATA BASED ON CRITERIA INCLUDED IN AN ELECTRONIC RECORD RECEIVED FROM A COMPUTING DEVICE

(71) Applicant: TOSHIBA TEC KABUSHIKI KAISHA, Tokyo (JP)

(72) Inventor: Katsuhito MOCHIZUKI, Mishima Shizuoka (JP)

(21) Appl. No.: 14/721,959

(22) Filed: May 26, 2015

(30) Foreign Application Priority Data
May 29, 2014 (JP) 2014-111519

(51) Int. Cl. G06Q 30/02; G06F 17/30

(52) U.S. Cl. CPC G06Q 30/0253; G06F 17/30864

(57) ABSTRACT

A server includes a database including a first table in which each of one or more merchandise codes is associated with one or more keywords and a second table in which each of one or more promotional programs is associated with one or more keywords and a time period, a communication unit that receives a command including a merchandise code from a mobile device, and a control unit. The control unit is configured to access the first table to retrieve one or more keywords associated with the received merchandise code, search the second table for one or more promotional programs associated with the retrieved keywords, and extract one or more promotional programs having an effective time period that includes a current time. When at least one promotional program is extracted, the communication unit transmits a response indicating that the merchandise code in the command is associated with a promotional program.

### CROSS-REFERENCE TO RELATED APPLICATION

This application is based upon and claims the benefit of priority from Japanese Patent Application No. 2014-111519, filed May 29, 2014, the entire contents of which are incorporated herein by reference.

### FIELD

Embodiments described herein relate generally to a server, particularly, a search engine server that searches data based on criteria included in an electronic record received from a computing device.

### BACKGROUND

One type of an electronic receipt system includes a server that generates an electronic data of a purchase transaction at a store (i.e., an electronic receipt), and the electronic receipt is transmitted to a computing device of a customer, such as a mobile device, instead of a paper receipt that is conventionally handed to the customer during the purchase transaction. The customer who received the electronic receipt on the computing device can confirm details of his or her purchase transaction by reviewing the electronic receipt displayed thereon.

When such an electronic receipt is transmitted to the customer's computing device, additional information, such as an advertisement, may be generated by the server and transmitted together with the electronic receipt.

However, it is difficult for the server to search information relevant to the purchase transaction efficiently and generate an advertisement that may effectively lead to sales.

### DESCRIPTION OF THE DRAWINGS

FIG. 1 illustrates the overall electronic receipt system including a server device according to an embodiment.

FIG. 2 is a sequence diagram illustrating a process of issuing an electronic receipt.

FIG. 3 is a block diagram of an electronic receipt management server in the electronic receipt system.

FIGS. 4A and 4B illustrate an electronic receipt management table and a communication destination designation table, respectively.

FIG. 5 illustrates a distribution work table.

FIG. 6 is a block diagram of a headquarter server in the electronic receipt system.

FIG. 7 illustrates tables stored in a database of the headquarter server.

FIG. 8 is a block diagram of a consumer terminal in the electronic receipt system.

FIG. 9 illustrates an example of an electronic receipt.

FIG. 10 is a flow chart of a distribution process carried out by the electronic receipt management server.

FIGS. 11A to 11C illustrates an example of the registration of order information in a distribution work table.

FIG. 12 illustrates an example of an updated electronic receipt.

FIG. 13 is a flow chart of processing carried out by the headquarter server.

FIG. 14 illustrates an example of the setting data in a determination result registration table.

FIGS. 15A and 15B are examples of a relevant advertisement.

### DETAILED DESCRIPTION

An embodiment provides a server device and a program which are capable of searching data associated with merchandise or a service included in a record transmitted from a computing device carried by a customer.

In general, according to one embodiment, a search engine server includes a database including a first table in which each of one or more merchandise codes is associated with one or more keywords and a second table in which each of one or more promotional programs is associated with one or more keywords and a time period, a communication unit that receives a command including a merchandise code from a mobile device, and a control unit. The control unit is configured to access the first table to retrieve one or more keywords associated with the received merchandise code, search the second table for one or more promotional programs associated with the retrieved keywords, and extract one or more promotional programs having an effective time period that includes a current time. When at least one promotional program is extracted, the communication unit transmits a response indicating that the merchandise code in the command is associated with a promotional program.

There is an electronic receipt system including a consumer terminal device (consumer terminal) through which an electronic receipt is provided instead of a paper receipt printed by a printing device in the system, when membership registration is performed.

Hereinafter, a description will be given by showing an example in which a server device according to the present embodiment is applied to a server device (headquarter server) of a headquarter office in an electronic receipt system that distributes electronic receipts to consumer terminals.

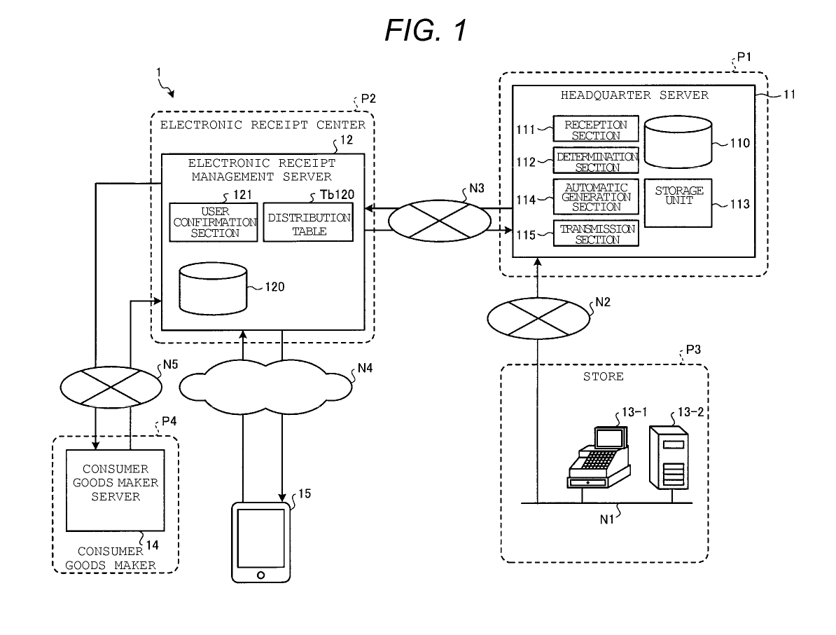

FIG. 1 illustrates the entire configuration of an electronic receipt system including a server device according to the present embodiment, as a headquarter server.

As illustrated in FIG. 1, an electronic receipt system 1 includes a headquarter server 11, an electronic receipt management server 12, a point of sales (POS) terminal 13-1, a store server 13-2, a consumer goods maker server 14, and a consumer terminal 15.

The headquarter server 11 is a server device located in a headquarter P1 of a company (retailer) that operates one or more stores P3 or chain stores (hereinafter, store).

The electronic receipt management server 12 is a server device located in an electronic receipt center P2, which is operated by a third party organization.

The POS terminal 13-1 is located in one of the stores P3. The number of POS terminals 13-1 provided in each store P3 is one or two or more.

The store server 13-2 is a server device located in each store P3 and controls the POS terminals 13-1.

The consumer goods maker server 14 is a server device located in a consumer goods maker P4.

The consumer terminal 15 is a terminal device which is used by a consumer in the customer's house, a movement destination, or the like.

The headquarter server 11 includes a database 110 that comprehensively manages merchandise sales data indicating details of purchase transactions and the like conducted by consumers using the POS terminal 13-1 in each store P3. Merchandise information, consumer's purchase history information, and other information regarding merchandise are registered in the database 110.

For example, as the merchandise information, a merchandise code for identifying merchandise, a merchandise name and a merchandise price associated with the merchandise code, and the like are registered in the database 110.

In addition, as the purchase history information, for example, a consumer's membership code and information indicating consumer's transaction details associated with the membership code are registered. Examples of the information indicating consumer's transaction details include the date of the purchase transaction, the name of a store, a merchandise code of purchased merchandise, a merchandise name, and the like, and some or all of them are included in receipt information.

In addition, as the other information regarding merchandise, promotion information (relevant information) and contents information used to display an advertisement (relevant advertisement) on the consumer terminal 15 are registered.

When a purchase transaction is performed using the POS terminal 13-1 in a store P3 and settlement processing is performed, receipt information of one transaction including all purchased merchandise is transmitted to the headquarter server 11 through the store server 13-2.

The headquarter server 11 registers the receipt information in the database 110 and manages the receipt information with respect to each member.

In addition, the headquarter server 11 converts the receipt information into an electronic receipt in accordance with the company's own predetermined conditions and a predetermined format, and manages the electronic receipt with respect to each member. The conditions and format for performing conversion into an electronic receipt may be determined based on, for example, the price range, type, and the like of the purchased merchandise as criteria for listing the merchandise in the electronic receipt. In the present embodiment, an electronic receipt, when displayed, includes an inquiry button and a designation button. Although details will be described below, the inquiry button is a button for inquiring presence or absence of relevant information of the purchased merchandise. In addition, the designation button is a button for requesting acquisition and display of a relevant advertisement. During format conversion for converting receipt information into an electronic receipt, the inquiry button is added to the electronic receipt. In addition, one or more designation buttons each are added to a position (for example, next to a merchandise name) which corresponds to the merchandise on the electronic receipt.

When a request for inquiring the presence or absence of relevant information or a request for acquiring a relevant advertisement is made in the consumer terminal 15, the electronic receipt management server 12 serves as a relay device, and an advertisement creation instruction (instruction of creation of a relevant advertisement for a predetermined merchandise item, and the like) is transmitted to the headquarter server 11 from the electronic receipt management server 12 in response to receiving the request.

The headquarter server 11 includes a reception section 111 for receiving the advertisement creation instruction.

The headquarter server 11 further includes a determination section 112 for determining presence or absence of relevant information. The determination section 112 accesses the database 110 by using the merchandise code included in the advertisement creation instruction received from the electronic receipt management server 12, as a search key. The determination section 112 determines an access result (determination result) to be “the presence of relevant information” when relevant information corresponding to the merchandise is found in the database 110, and “the absence of relevant information” when relevant information corresponding to the merchandise is not found.

The headquarter server 11 further includes a storage unit 113 that stores content data (a still image, a movie, or the like) which is used to generate a relevant advertisement. The relevant advertisement will later become a promotion advertisement displayed on the consumer terminal 15 in association with an electronic receipt.

In addition, the headquarter server 11 includes an automatic generation section 114 that generates a relevant advertisement by collecting pieces of content data stored in the storage unit 113. The automatic generation section 114 automatically generates a relevant advertisement based on relevant information corresponding to the merchandise code included in the advertisement creation instruction.

The headquarter server 11 further includes a transmission section 115 for transmitting information indicating the access result obtained by the determination section 112 and information associated with the access result, in response to the advertisement creation instruction. Here, the information associated with the access result indicates, for example, information (relevant advertisement information) of the relevant advertisement generated by the automatic generation section 114, and the like.

The electronic receipt management server 12 centrally manages electronic receipts which are managed by the respective headquarter servers 11 of multiple companies. The electronic receipt management server 12 receives electronic receipts in the respective company's own formats from the headquarter server 11, and manages the electronic receipts associated with the corresponding company codes in the database 120. In addition, when the electronic receipt management server 12 receives a request for an electronic receipt from the consumer terminal 15, the electronic receipt management server 12 transmits (distributes) the electronic receipt to the consumer terminal 15. The electronic receipt management server 12 appropriately converts the electronic receipt in accordance with the environment of the consumer terminal 15 when transmitting the electronic receipt.

In addition, the electronic receipt management server 12 includes a section that deals with the inquiry of the presence or absence of relevant information received after the request for the electronic receipt from the consumer terminal 15 and a request for acquisition of a relevant advertisement. For example, the section is a distribution table Tb120 that is operated to distribute the requests among servers, each dealing with its corresponding merchandise. In the present embodiment, a communication address (an IP address, URL information, or the like) of the company's headquarter server 11 and a communication address (an IP address, URL information, or the like) of the consumer goods maker server 14 are set in the distribution table Tb120, as the distribution destination thereof.

In addition, the electronic receipt management server 12 includes a user confirmation section 121 that sets user confirmation information in an electronic receipt and transmits the set user confirmation information to the consumer terminal 15 when the electronic receipt management server 12 acquires transmission information indicating the presence of a relevant advertisement from the headquarter server 11 or the consumer goods maker server 14. The user confirmation information refers to information indicating that relevant advertisement of merchandise may be displayed, on the consumer terminal 15, and is displayed as an operable button.

In addition, the electronic receipt management server 12 transmits relevant advertisement to the consumer terminal 15 in correlation with an electronic receipt when the electronic receipt management server 12 acquires the relevant advertisement from the headquarter server 11 or the consumer goods maker server 14.

The POS terminal 13-1 processes merchandise sales data. In this process, a series of merchandise transactions is performed on each consumer. For example, when a salesperson causes merchandise to be purchased by a consumer, to be read by a reading device such as a scanner, the POS terminal 13-1 performs an inquiry of the merchandise in a merchandise data file of the store server 13-2, and then performs a settlement process when all of the merchandise items are identified. In addition, the POS terminal 13-1 performs a process of confirming with a consumer (member) whether or not an electronic receipt is preferred with respect to each purchase transaction, for example, by displaying a confirmation button on a display screen. In this process, when the consumer expresses his or her preference of an electronic receipt, a consumer's membership code is read using a reading device such as a camera, a bar code scanner, or a card reader.

After the merchandise to be purchased is fixed, the POS terminal 13-1 uploads merchandise sales data for the transaction of the consumer to the store server 13-2. When the consumer's membership code is read, the POS terminal 13-1 uploads the merchandise sales data having the membership code added to the store server 13-2.

The store server 13-2 manages merchandise sales data processing which is performed by one or more POS terminals 13-1 in the store P3. The store server 13-2 stores and manages a merchandise data file, which is used to perform merchandise inquiry in the POS terminal 13-1. In addition, the store server 13-2 stores and manages consumer's merchandise sales data obtained as a result of the merchandise sales data processing. In this manner, the store server stores and manages data regarding merchandise for sale and purchase transactions.

In addition, the store server 13-2 regularly accesses the headquarter server 11 and performs data synchronization with the headquarter server 11. For example, the store server 13-2 downloads the latest merchandise information from the headquarter server 11 or uploads the consumer's merchandise sales data obtained through the merchandise sales data processing to the headquarter server 11.

The consumer goods maker server 14 is a server belonging to a maker that mainly deals with merchandise managed by a standardized code. As the standardized code, a Japanese article number (JAN) code is used in Japan. In addition, a European article number (EAN) code is used in Europe and the like, and a universal product code (UPC) is used in the United States. Here, it is assumed that the consumer goods maker server 14 manages merchandise information using the JAN code. Also, in the present embodiment, the consumer goods maker server 14 stores a predetermined banner advertisement. When the consumer goods maker server 14 receives advertisement creation instruction from the electronic receipt management server 12, the consumer goods maker server 14 transmits the banner advertisement to the electronic receipt management server 12.

The consumer terminal 15 is a mobile terminal, such as a smart phone or a tablet terminal. Although a portable terminal is described in the present embodiment, the exemplary embodiment is not limited thereto, and a non-portable personal computer located in a consumer's house may be used instead of the portable terminal 15. The consumer terminal 15 includes a storage unit that stores a membership code.

When a consumer performs membership registration of an electronic receipt, a member code (number) is issued. The membership code is stored in an IC card or a magnetic card or in the storage unit of the consumer terminal 15. The membership code is stored in the storage unit in the form of, for example, a QR code (registered trademark), a two-dimensional bar code, or the like. The consumer expresses the preference of receiving an electronic receipt by causing the membership code to be read by a camera or a reader as a reading device included in the POS terminal 13-1 when the purchase transaction is performed at the POS terminal 13-1.

In addition, the consumer terminal 15 includes an application that manages information regarding an electronic receipt and displays the electronic receipt, a relevant advertisement, and the like on a display screen thereof. The consumer terminal 15 accesses the electronic receipt management server 12 to transmit a password and a membership code, and downloads the electronic receipt, the relevant advertisement, and the like from the electronic receipt management server 12 if authentication of the password and the membership code are successfully performed. The application can designate particular electronic receipts to be acquired from the electronic receipt management server 12 by a transaction date and time, a transaction store, and the like. In addition, the application can display the downloaded electronic receipt, relevant advertisement, and the like on the display screen.

The above-described devices in the electronic receipt system 1 may be connected to each other through a public line, a dedicated line, or the like. Each of communication networks N1 to N5 may be an in-store network, a mobile network of a mobile phone, a public network such as a telephone line, an Internet network, or a combination network thereof.

The POS terminal 13-1 and the store server 13-2 are located within an in-store network such as a local area network (LAN) of the store P3.

The headquarter server 11 is configured to be connected to the electronic receipt management server 12, the store server 13-2, and the like through a dedicated line such as a virtual private network (VPN).

The consumer goods maker server 14 is configured to be connected to the electronic receipt management server 12 through a dedicated line.

The consumer terminal 15 is connected to a telephone network through a wireless base station, and is connected to the electronic receipt management server 12 through the Internet or the like.

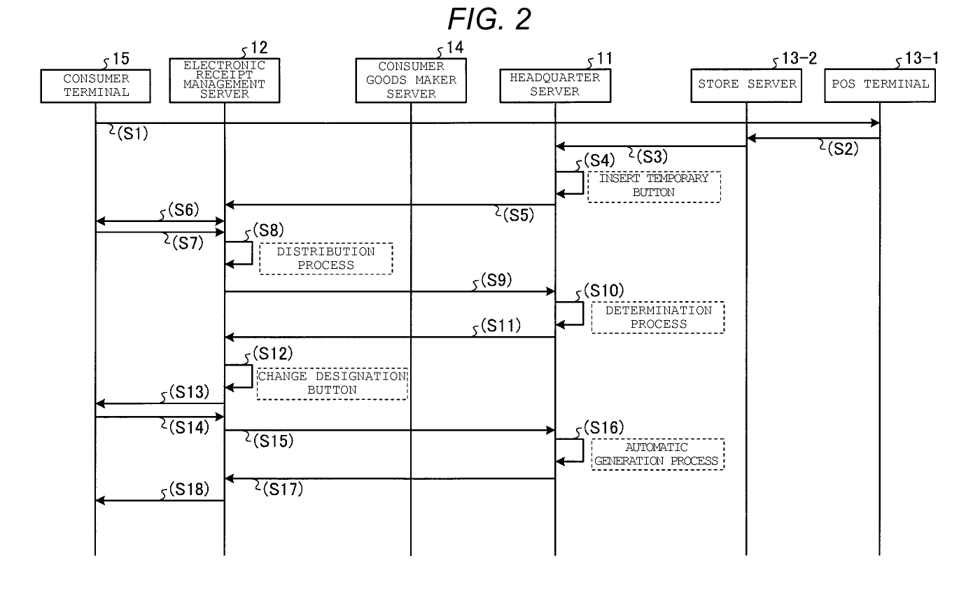

In such a configuration, a process of issuing an electronic receipt is performed through the following procedure. FIG. 2 is a sequence diagram of the process of issuing an electronic receipt performed by the electronic receipt system 1. In FIG. 2, a distribution destination in the electronic receipt management server 12 is limited to the headquarter server 11. Although the distribution to the consumer goods maker server 14 may be also performed, the distribution to the consumer goods maker server 14 will be shown without the sequence diagram.

First, a process of scanning all merchandise items to be purchased is carried out using the POS terminal 13-1 and the series of settlement processes is completed. During these processes, the consumer causes the POS terminal 13-1 to read a membership code by holding up the consumer terminal 15 near the reader of the POS terminal 13-1 to show preference of an electronic receipt regarding the purchase transaction (S1).

Next, the membership code is transmitted to the store server 13-2 together with transaction data indicating transaction details based on the preference of the customer (S2), and is then uploaded to the headquarter server 11 (S3).

Next, the headquarter server 11 generates an electronic receipt in a predetermined format from the transaction data (S4), and transmits the electronic receipt to the electronic receipt management server 12 (S5). The headquarter server 11 adds an inquiry button for inquiring the presence or absence of relevant information and a designation button for acquiring an advertisement relevant to the electronic receipt during step S4. Here, the designation button added at this time is an inoperable button only for display.

The electronic receipt management server 12 manages the electronic receipt received from the headquarter server 11 in this manner with respect to each company and each member.

Thereafter, a consumer starts up an electronic receipt application on the consumer terminal 15 within a store or a customer's house and accesses the electronic receipt management server 12 (S6). At this time, the consumer terminal 15 transmits a membership code and a password to the electronic receipt management server 12 to establish authentication. In addition, the consumer terminal 15 transmits a search key (for example, a particular date and time, and the like of the purchase transaction) which is used to extract one or more electronic receipts. On the other hand, the electronic receipt management server 12 extracts one or more electronic receipts using the membership code and the search key transmitted from the consumer terminal 15, and transmits the extracted electronic receipts to the consumer terminal 15. The consumer terminal 15 receives the electronic receipts transmitted from the electronic receipt management server 12, and displays the electronic receipts on a display screen using the electronic receipt application.

Here, the consumer presses the inquiry button of relevant information displayed on the display screen of the consumer terminal 15. Then, the consumer terminal 15 requests the electronic receipt management server 12 to transmit information regarding the presence or absence of relevant information (S7).

When the electronic receipt management server 12 receives the request for transmission, the electronic receipt management server 12 specifies a communication address of a server that stores information of the merchandise displayed on the consumer terminal 15, from the distribution table Tb120 (S8).

Then, the electronic receipt management server 12 transmits advertisement creation instruction as a request for the inquiry of the presence or absence of relevant information to the server, which is a distribution destination (S9).

When the headquarter server 11 receives the advertisement creation instruction in the reception section 111, the determination section 112 determines whether or not relevant information associated with the merchandise included in the advertisement creation instruction is present (S10). When the advertisement creation instruction includes a plurality of merchandise items, the determination section 112 determines the presence or absence of relevant information with respect to each of the merchandise items.

The headquarter server 11 transmits information indicating a determination result such as “the presence of relevant information” or “the absence of relevant information,” which is obtained by the determination section 112, to the electronic receipt management server 12 through the transmission section 115 (S11).

When the information indicating the determination result which is transmitted from the headquarter server 11 indicates “the presence of relevant information,” the user confirmation section 121 changes the designation button to an operable button (S12). The change to an operable button is performed, for example, by changing the color of the designation button, and displaying character information indicating that the button is selectable, on the designation button, and then allocating processing details to be performed to the designation button. In addition, when the information indicating the determination result which is transmitted from the headquarter server 11 indicates “the absence of relevant information,” the distinction from a selectable button is made clear. Specifically, the distinction from a selectable button is made clear by displaying character information indicating that the button cannot be selected on the designation button or by leaving the designation button as it is without changing the designation button.

Meanwhile, in step S8, when the consumer goods maker server 14 that manufactures the merchandise specified by a JAN code is a distribution destination, the processes of step S9 to step S11 are omitted without transmitting the advertisement creation instruction to the consumer goods maker server 14. Then, the flow proceeds to the process of step S12 to change the designation button to an operable button.

As described above, the electronic receipt management server 12 modifies each designation button to be an operable button so that the user of the consumer terminal 15 can recognize the presence of a relevant advertisement for each merchandise item, in the process of step S12.

Next, the electronic receipt management server 12 transmits an electronic receipt including the reset designation button to the consumer terminal 15 (S13).

The consumer terminal 15 receives an electronic receipt in which the designation button is modified, and updates display information.

Thereafter, a consumer presses the designation button indicating the presence of relevant information to generate a request (S14). Then, the electronic receipt management server 12 receives this request, distributes the request again to the server to which the presence or absence of relevant information regarding designated merchandise has been inquired, as the advertisement creation instruction (S15).

When the headquarter server 11 receives the advertisement creation instruction, the automatic generation section 114 generates a relevant advertisement of the merchandise (S16).

Subsequently, the headquarter server 11 transmits the generated relevant advertisement to the electronic receipt management server 12 (S17).

The electronic receipt management server 12 transmits the relevant advertisement received from the headquarter server 11 to the consumer terminal 15 that originated the request (S18).

On the other hand, when the consumer goods maker server 14 that manufactures the merchandise specified by a JAN code is a distribution destination in step S15, a banner advertisement is acquired from the consumer goods maker server 14 in the processes of step S16 and step S17. Then, an electronic receipt having the banner advertisement added thereto is transmitted to the consumer terminal 15 that originated the request in step S18.

According to the above-described procedure, the consumer terminal 15 may display the relevant advertisement and the banner advertisement which are received from the electronic receipt management server 12 on the display screen.

In the present embodiment, it is assumed that the banner advertisement is acquired from the consumer goods maker server 14, but the exemplary embodiment is not limited thereto. For example, a banner advertisement for each consumer goods maker server 14 may be registered in the electronic receipt management server 12 in advance. In addition, the electronic receipt management server 12 may add a banner advertisement corresponding to merchandise to an electronic receipt without accessing the consumer goods maker server 14 and transmits the banner advertisement to the consumer terminal 15.

Next, the display of the relevant advertisement will be described in more detail.

Hereinafter, it is assumed that an electronic receipt and relevant advertisement are described by a structured document (for example, an HTML, an XHTML, or an XML). In addition, a Web browser is used as an application for displaying an electronic receipt on the consumer terminal 15.

However, the Web browser using a structured document is an example, and other configurations may be adopted. For example, all of various display data (including a content) may be downloaded to the consumer terminal 15 and displayed on a display screen using a dedicated application.

In the following description, it is assumed that information such as an electronic receipt is created as a structured document by the headquarter server 11, unless specified otherwise. In addition, the headquarter server 11 and the electronic receipt management server 12 exchange telegraphic messages with each other, and it is assumed that data received from the headquarter server 11 is appropriately converted on the server side of the electronic receipt management server 12 into a format capable of being displayed on the consumer terminal 15, that is, an HTML or XHTML format.

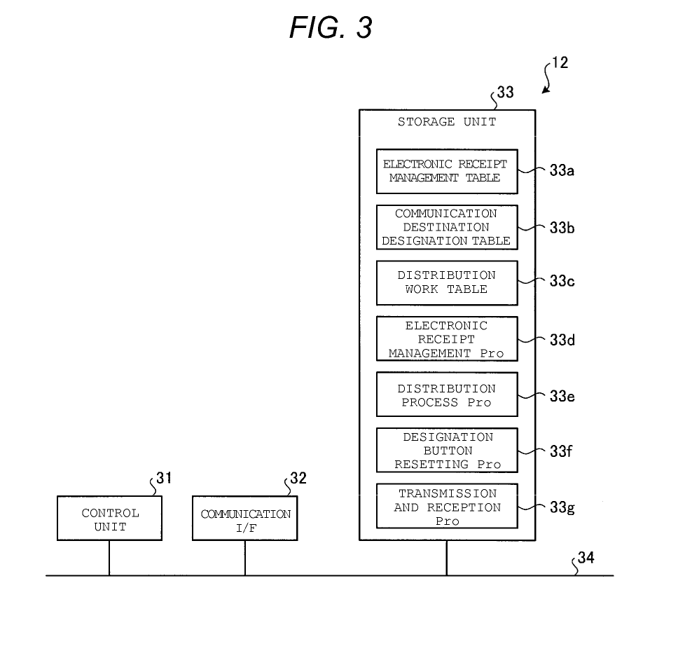

First, the configuration of the electronic receipt management server 12 will be described. FIG. 3 is a block diagram of the electronic receipt management server 12. The electronic receipt management server 12 mainly includes a control unit 31, a communication I/F 32, and a storage unit 33. The units are connected to each other through a bus 34.

The control unit 31 performs various computations and comprehensively controls the units of the electronic receipt management server 12. The control unit 31 includes a CPU, a ROM that stores various programs and data, a RAM that is used as a work, temporarily stores various programs, and stores various data so as to be rewritable, an RTC unit that indicates the current date and time, and the like.

The communication I/F 32 is a communication interface for the connection to networks N3, N4, and N5.

The storage unit 33 is a storage device such as a memory or a hard disk. The storage unit 33 contains a storage region 33a storing an electronic receipt management table. The storage unit 33 also contains a storage region 33b storing a distribution destination designation table and a storage region 33c storing a distribution work table. In this embodiment, the distribution table Tb120 illustrated in FIG. 1 includes the distribution destination designation table and the distribution work table.

The storage unit 33 also stores an electronic receipt management program (in FIG. 3, “program” is abbreviated as “Pro”) 33d and a distribution process program 33e. In addition, the storage unit 33 stores a designation button resetting program 33f, a transmission and reception program 33g, and the like.

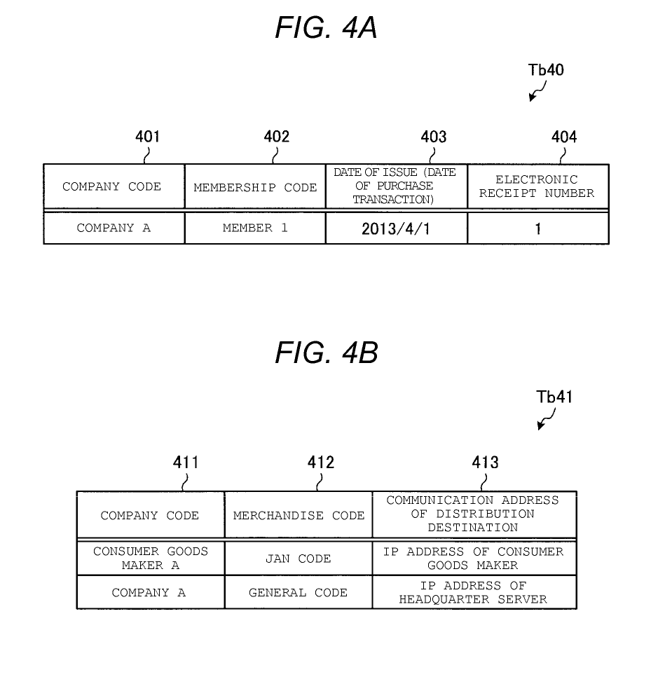

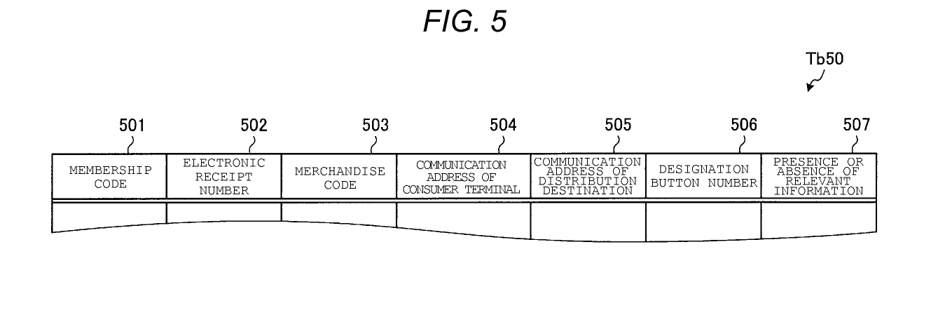

Hereinafter, configurations of the electronic receipt management table, the distribution destination designation table, and the distribution work table will be described with reference to FIGS. 4A and 4B and FIG. 5.

FIGS. 4A and 4B illustrate the configurations of an electronic receipt management table and a distribution destination designation table.

FIG. 4A illustrates an example of an electronic receipt management table Tb40. In FIG. 4A, a “company code” 401, a “membership code” 402, a “date of issue” 403, an “electronic receipt number” 404, and the like are illustrated as main items (fields) of the electronic receipt management table Tb40. Only one record is illustrated in FIG. 4A as an example of record information.

The “company code” 401 indicates an identification code which is assigned to each company. The identification code includes a unique identification code including a combination of a number and characters for specifying the headquarter server 11. In FIG. 4A, a company's identification code is shown as “company A” for convenience of description.

The “membership code” 402 indicates an identification code which is assigned to a member registered in the electronic receipt system. The identification code includes a unique identification code including a combination of a number and characters for specifying each member. In FIG. 4A, a member's identification code is shown as “member 1” for convenience of description.

The “date of issue” 403 indicates the date and time when the purchase transaction has been carried out using the POS terminal 13-1 (see FIG. 1). In FIG. 4A, the date of Apr. 1, 2013 is shown as “2013/4/1.”

The “electronic receipt number” 404 indicates a management number of an electronic receipt which is assigned to each purchase transaction. The management number is a serial number which is assigned to the member thereof each time an electronic receipt is issued. In FIG. 4A, “1” at the beginning of the serial number is shown.

FIG. 4B illustrates an example of a distribution destination designation table Tb41. As illustrated in FIG. 4B, the distribution destination designation table Tb41 mainly includes a “company code” 411, a “merchandise code” 412, a “communication address of distribution destination” 413, and the like.

The “company code” 411 corresponds to the “company code” 401 of the electronic receipt management table Tb40 illustrated in FIG. 4A. As an example, the record information shows “company A” as a company code of a company that manages the headquarter server 11, and shows “consumer goods maker A” as a company code of the consumer goods maker server 14.

The “merchandise code” 412 indicates an identification code assigned to merchandise. The identification code includes a JAN code and a general code. The JAN code is a merchandise code in a predetermined format which is assigned by the consumer goods maker server 14. The general code is a merchandise code in a format assigned by the company (retailer). The general code is an identification code which is used only within the company.

The “communication address of distribution destination” 413 indicates communication addresses of the headquarter server 11 or the consumer goods maker server 14, which are distribution destinations. When the “merchandise code” 412 is a general code, a communication address of the headquarter server 11 of a company associated with the general code is registered. In addition, when the “merchandise code” 412 is a JAN code, a communication address of the consumer goods maker server 14 that manufactures a product having the JAN code is registered. Accordingly, a communication address of the headquarter server 11 or the consumer goods maker server 14 of the corresponding company is registered in accordance with whether the “merchandise code” 412 is a general code or a JAN code and in accordance with the “merchandise code” 412, in the “communication address of distribution destination” 413.

Here, data registered in the distribution destination designation table Tb41, such as the general code and the communication address, are received in advance from a company participating to the electronic receipt system 1, and registered. The JAN code and the communication address are also obtained in advance from a consumer goods maker, and registered.

Hereinafter, it is assumed that data is registered in advance in the distribution destination designation table Tb41, i.e., the “company code” 411, the “merchandise code” 412, and the “communication address of distribution destination” 413.

FIG. 5 illustrates an example of a distribution work table Tb50 (also referred to as a work table Tb50). The distribution work table Tb50 is a work table which is temporarily used at the time of executing the distribution process program 33e.

As illustrated in FIG. 5, the distribution work table Tb50 includes a “membership code” 501, an “electronic receipt number” 502, a “merchandise code” 503, a “communication address of consumer terminal” 504, a “communication address of server device as distribution destination” 505, a “designation button number” 506, a “presence or absence of relevant information” 507, and the like.

The “membership code” 501 corresponds to the “membership code” 402 of the electronic receipt management table Tb40 of FIG. 4A. The “membership code” 501 indicates an identification code assigned to a member registered in the electronic receipt system 1.

The “electronic receipt number” 502 corresponds to the “electronic receipt number” 404 of the electronic receipt management table Tb40 of FIG. 4A. The “electronic receipt number” 502 indicates a management number of an electronic receipt which is assigned to each transaction.

The “merchandise code” 503 corresponds to the “merchandise code” 412 of the communication destination designation table Tb41 of FIG. 4B. The “merchandise code” 503 indicates an identification code assigned to merchandise.

The “communication address of consumer terminal” 504 is indicates a communication address of the consumer terminal 15 associated with the member.

The “communication address of server device as distribution destination” 505 corresponds to the “communication address of distribution destination” 413 of the communication destination designation table Tb41 of FIG. 4B. A distribution destination communication address extracted from the communication destination designation table Tb41 is stored therein.

The “designation button number” 506 indicates a serial number assigned to each designation button with respect to each electronic receipt.

The “presence or absence of relevant information” 507 indicates the presence or absence of relevant information. In this example, it is assumed that “1” is stored when relevant information is present, and “0” is stored when relevant information is not present.

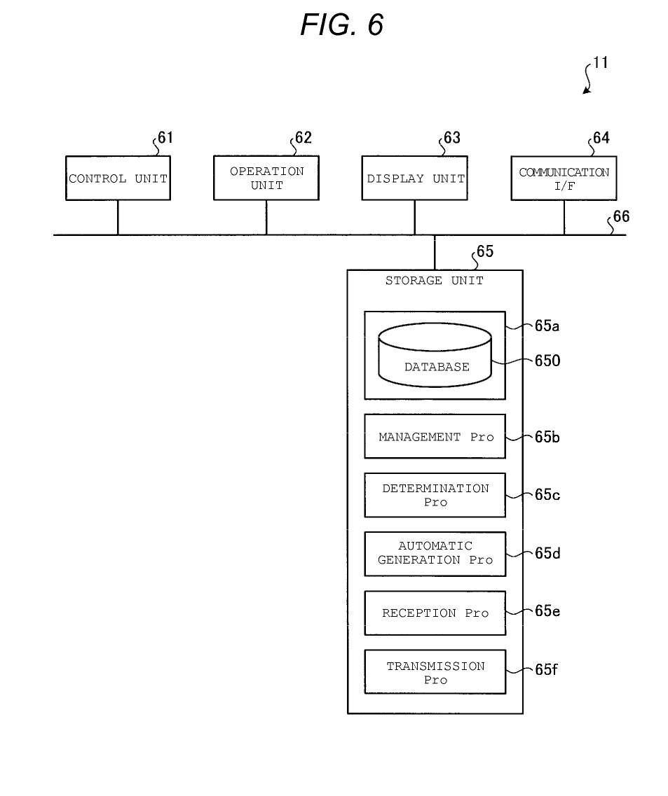

Next, the configuration of the headquarter server 11 will be described. FIG. 6 is a block diagram of the headquarter server 11. The headquarter server 11 mainly includes a control unit 61, an operation unit 62, a display unit 63, a communication I/F 64, and a storage unit 65. The units are connected to each other through a bus 66.

The control unit 61 performs various computations and comprehensively controls the units of the headquarter server 11. The control unit 61 includes a CPU, a ROM that stores various programs and data, a RAM that is used for work, temporarily stores various programs, and stores various data so as to be rewritable, an RTC unit that indicates the current date and time, and the like.

The operation unit 62 is an input device that transmits an input signal corresponding to an operated key of a keyboard to the control unit 61, for example, in response to an input operation such as pressing of the key. The operation unit 62 transmits a predetermined command code and data to the control unit 61.

The display unit 63 is a display device that displays display data generated by the control unit 61 on a display screen such as a liquid crystal display.

The communication I/F 64 is a communication interface for the connection to the network N2 and the network N3. The headquarter server 11 accesses the electronic receipt management server 12 and the like through the communication I/F 64, and receives advertisement creation instruction and the like.

The storage unit 65 is a storage device such as a memory or a hard disk. The storage unit 65 contains a storage region 65a storing a database 650 (equivalent to the database 110 of FIG. 1). The database 650 includes various tables for registering merchandise sales data indicating details of each purchase transaction, relevant information of merchandise, information used for a relevant advertisement, and the like.

In addition, the storage unit 65 stores various programs for relevant information and a relevant advertisement. For example, the programs include a management program 65b for managing the database 650, a determination program 65c for determining the presence or absence of relevant information, and an automatic generation program 65d for generating a relevant advertisement. In addition, a reception program 65e for receiving advertisement creation instruction, and a transmission program 65f for transmitting relevant advertisement, determination result information, and the like are also stored.

A merchandise code (general code) and merchandise information, such as a merchandise name and a merchandise price, associated with each merchandise code are registered in the database 650. In addition, a membership code of an electronic receipt member, and consumer's purchase history information including receipt information, such as a transaction date and time (purchase date and time), a used store name, a merchandise code of purchased merchandise, and a merchandise name of purchased merchandise which are associated with the membership code, are registered. In addition, relevant information used for promotion with respect to a consumer who has purchased merchandise, information regarding a relevant advertisement, and the like are registered.

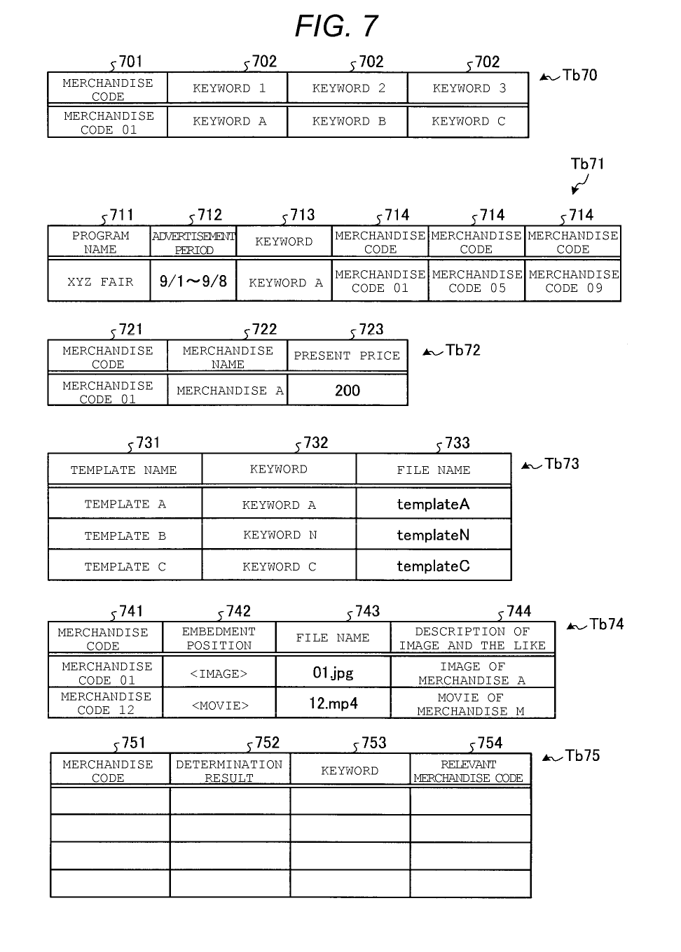

FIG. 7 illustrates an example of a table of the database 650. As illustrated in FIG. 7, the database 650 includes a relevant table Tb70, a program master table Tb71, a merchandise master table Tb72, a template table Tb73, a content table Tb74, and a determination result registration table Tb75 (also referred to as a work table Tb75) as primary work tables.

First, the relevant table Tb70 includes a “merchandise code” 701 and a “keyword” 702. The “merchandise code” 701 corresponds to the “merchandise code” 412 of the communication destination designation table Tb41 of FIG. 4B. A general code used in a company that manages the headquarter server 11 is stored therein.

The “keyword” 702 indicates keyword information regarding merchandise. The number of the “keyword” 702 is two or more like “keyword 1”, “keyword 2”, and “keyword 3”. Keyword information included in each of the “keyword 1”, the “keyword 2”, and the “keyword 3” is associated with the merchandise code of the “merchandise code” 701. It is possible to associate a plurality of keywords with one merchandise code by registering a plurality of keywords in the “keyword” 702.

The keyword registered in the “keyword 1”, the “keyword 2”, the “keyword 3”, and the like are used as keys for extracting relevant information of merchandise. Accordingly, in the example illustrated in FIG. 7, it is possible to use three keywords of “keyword A”, “keyword B”, and “keyword C” for the extraction of relevant information of the merchandise indicated by “merchandise code 01”.

Although this will not be described particularly, the relevant table Tb70 in FIG. 7 and the other tables Tb71 to Tb75 (described below) may show part of records stored therein, and the other records may be omitted.

The program master table Tb71 includes a “program name” 711, an “advertisement period” 712, a “keyword” 713, a “merchandise code” 714, and the like.

The “program name” 711 indicates a name (program information) of a promotion program.

The “advertisement period” 712 indicates a promotion period of the program. Information (promotion period information), which indicates a promotion period before the promotion program starts is registered in this slot.

The “keyword” 713 corresponds to the “keyword” 702 of the relevant table Tb70. The “keyword” 713 serves as a key for extracting information of the “program name” 711.

The “merchandise code” 714 corresponds to the “merchandise code” 701 of the relevant table Tb70. A plurality of merchandise codes may be registered in the “merchandise code” 714.

The merchandise master table Tb72 includes a merchandise code and detailed information of merchandise. In FIG. 7, a “merchandise code” 721, and a “merchandise name” 722 and a “present price” 723 as detailed information of merchandise are shown.

The “merchandise code” 721 corresponds to the “merchandise code” 701 of the relevant table Tb70. The “merchandise code” 721 indicates general codes of all merchandise items sold or manufactured by the company.

The “merchandise name” 722 indicates a name of merchandise.

The “present price” 723 indicates the present price of the merchandise. The latest merchandise price is registered in this slot as updatable merchandise price information.

The above-described information in the merchandise master table Tb72 are always updated. The information are updated whenever merchandise information such as, for example, a merchandise price is changed. In addition, when a new merchandise item is added, the merchandise information thereof is included.

The template table Tb73 is a table for designating a template file when generating a relevant advertisement of merchandise. As illustrated in FIG. 7, the template table Tb73 includes a “template name” 731, a “keyword” 732, and a “file name” 733.

The “template name” 731 indicates a name of the template file.

The “keyword” 732 corresponds to the “keyword” 702 of the relevant table Tb70. a key for specifying a template is registered in the “keyword” 732.

The “file name” 733 indicates a path of a template and a file name. A path (not shown in FIG. 7), which indicates a location of the template file, and a file name are registered in this slot.

The content table Tb74 is a table for managing content data to be embedded into a template. As illustrated in FIG. 7, the content table Tb74 includes a “merchandise code” 741, an “embedment position” 742, and a “file name” 743. In the FIG. 7, a description of image 744 is also illustrated.

The “merchandise code” 741 corresponds to the “merchandise code” 701 of the relevant table Tb70. A merchandise code of merchandise corresponding to a content designated by the “file name” 743 is registered therein.

The “embedment position” 742 indicates an embedment position designated in a template. Information (an index number, tag information, and the like) indicating an embedment position on a template is registered in this slot.

The “file name” 743 indicates a path of content data and a file name. A path (not shown in FIG. 7) indicating the location of the file of the content data and a file name are registered in this slot.

The determination result registration table Tb75 is a primary work table which is used when executing the determination program 65c and the automatic generation program 65d.

The determination result registration table Tb75 includes a “merchandise code” 751, a “determination result” 752, a “keyword” 753, and a “relevant merchandise code” 754.

The “merchandise code” 751 corresponds to the “merchandise code” 701 of the relevant table Tb70. A merchandise code of merchandise for which the determination of the presence or absence of relevant information has been performed is temporarily registered in the “merchandise code” 751.

The “determination result” 752 indicates the presence or absence of relevant information which is obtained by executing the determination program 65c. In this example, as illustrated in FIG. 7, “1” is registered for the merchandise that has been determined to have relevant information, and “0” is registered for the merchandise that has been determined to have no relevant information.

The “keyword” 753 corresponds to the “keyword” 713 of the program master table Tb71. A keyword extracted by executing the determination program 65c is registered in the “keyword” 753.

The “relevant merchandise code” 754 corresponds to the “merchandise code” 714 of the program master table Tb71. A merchandise code of a related merchandise extracted by executing the determination program 65c is registered in the “relevant merchandise code” 754.

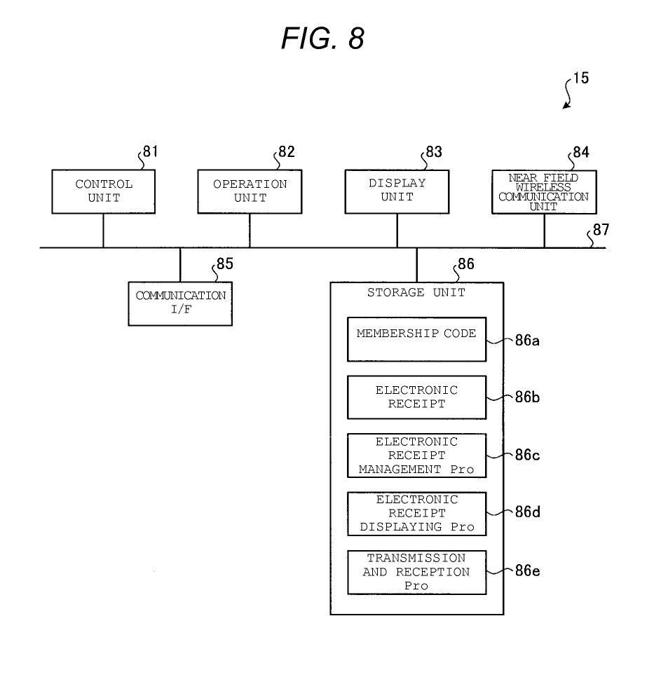

Subsequently, the configuration of the consumer terminal 15 will be described. FIG. 8 is a block diagram of the consumer terminal 15. The consumer terminal 15 mainly includes a control unit 81, an operation unit 82, a display unit 83, a near field wireless communication unit 84, a communication I/F 85, and a storage unit 86. The units are connected to each other through a bus 87.

The control unit 81 performs various computations and comprehensively controls the units of the consumer terminal 15. The control unit 81 includes a CPU, a ROM that stores various programs and data, a RAM that is used as a work, temporarily stores various programs, and stores various data so as to be rewritable, an RTC unit that indicates the current date and time, and the like.

The operation unit 82 is an input device that transmits an input signal from, for example, a touch panel display to the control unit 81. The operation unit 82 inputs a predetermined command code and data to the control unit 81 through an interface such as an input button on a liquid crystal display.

The display unit 83 is a display device that displays display data generated by the control unit 81. For example, the display data is displayed on a touch panel display.

The near field wireless communication unit 84 is a communication interface that transmits and receives data by performing wireless communication with the near field wireless communication unit (not shown) of the POS terminal 13-1.

The communication I/F 85 is a communication interface for the connection to the network N4, in other words, for having access to the Internet through a mobile phone network or the like.

The storage unit 86 is a storage device such as a built-in memory or a detachable external storage device (for example, a flash memory). The storage unit 86 contains a storage region 86a of a membership code and an electronic receipt management region 86b, and stores an electronic receipt management program 86c, an electronic receipt displaying program 86d, a transmission and reception program 86e, and the like.

The electronic receipt management region 86b is a storage region for storing downloaded electronic receipt and relevant advertisement, and the like.

The electronic receipt management program 86c is a program for managing the electronic receipt stored in the electronic receipt management region 86b. In addition, the electronic receipt management program 86c is a program for selectively downloading an electronic receipt from the electronic receipt management server 12. A process of selecting one or more electronic receipts as a target receipt based on, for example, a transaction date and time, a store, and the like is performed.

The electronic receipt displaying program 86d is a program (Web browser) for providing a user interface for requesting an electronic receipt, a relevant advertisement of listed merchandise, and the like from the electronic receipt management server 12, to a display screen, and for displaying the electronic receipt, the relevant advertisement, and the like received from the electronic receipt management server 12 on a display screen.

The transmission and reception program 86e is a program for performing data communication with the electronic receipt management server 12 and the like using a predetermined protocol (HTTP).

Subsequently, a process of displaying relevant advertisement of FIG. 2 will be described in detail.

First, the process of step S4 of FIG. 2, that is, a process of disposing on an electronic receipt an inquiry button for inquiring the presence or absence of relevant information and a designation button for designating a relevant advertisement stored in the headquarter server 11 will be described.

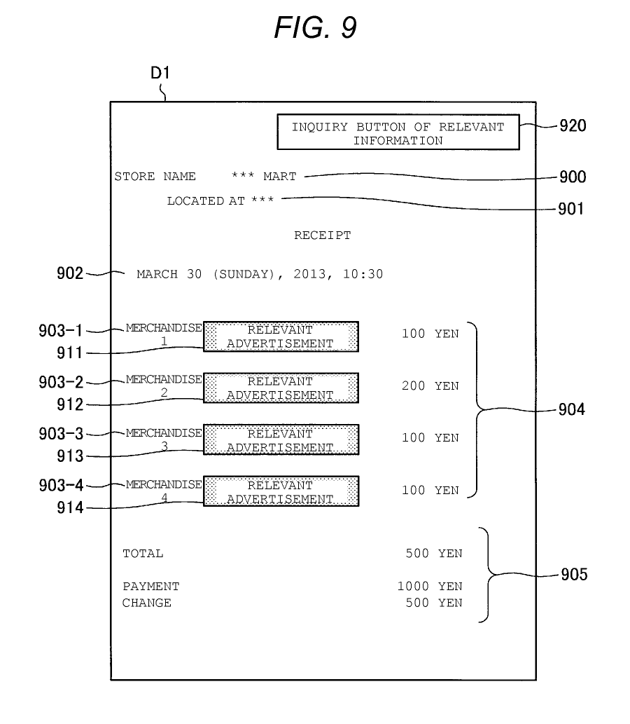

FIG. 9 illustrates an example of an electronic receipt including an inquiry button and a designation button. An electronic receipt D1 shown in FIG. 9 is configured by analyzing a predetermined template for an electronic receipt and setting various data.

In the template for an electronic receipt, a data embedment position is designated in advance at a predetermined position on the template using a tag or the like. In addition, the attribution of data to be embedded and the like are designated by giving attribution information and the like to the tag.

A position and data are specified by reading the tag information during the analysis of the template, and the following predetermined data is set at the position.

A store name 900, a store 901, a transaction date and time 902, merchandise names 903-1 to 903-4, a merchandise amount of money 904, a transaction amount of money 905, and the like illustrated in FIG. 9 are information that may vary depending on a member, a transaction date and time, and the like. As attributes such as key information is set to each tags, target information can be acquired from the corresponding receipt information by designating the attributes.

In addition, position of each of designation buttons 911 to 914 is designated in the template in advance so that the designation buttons are displayed next to the merchandise names 903 of all merchandise items. When the designation buttons 911 to 914 include image data such as a GIF, a file name and a path of a designation button image are set in tags shown in the positions of the designation buttons 911 to 914. As the button image, two types of images having different colors are prepared, and a file of a color (for example, gray) indicating that the button is invalid is designated here. In this example, a color indicating that the button is valid is white, and a color indicating that the button is invalid is gray (shown by a shaded portion in FIG. 9). Thereby, it is possible to determine whether the button image is valid or invalid by a color at a glance.

Alternatively, the button may be generated using a CSS extension function without using a button image. In addition, the position of an inquiry button 920 of relevant information is also prepared in a template in advance, and the inquiry button is displayed in an upper portion or the like of the receipt. When the inquiry button 920 includes an image such as a GIF, a file name and a path of an inquiry button image are set in a tag indicating the position of the inquiry button 920.

Thereby, the headquarter server 11 sets pieces of receipt information 900 to 905 and various buttons 911 to 914 and 920 as predetermined data at predetermined positions by analyzing the template, and thereby generates the electronic receipt D1 illustrated in FIG. 9.

The electronic receipt D1 is transmitted to the consumer terminal 15 after the electronic receipt management server 12 associates an execution command to the inquiry button 920 of the presence or absence of relevant information. Accordingly, in the consumer terminal 15 receiving the electronic receipt, when the inquiry button 920 is operated, a request for the inquiry of the presence or absence of relevant information is issued to the electronic receipt management server 12. On the other hand, the designation buttons 911 to 914 are displayed by a gray color, and an execution command is not associated. For this reason, the designation buttons 911 to 914 are set to be in an inoperable state, and thus no operation is performed even when the user attempts to select the buttons.

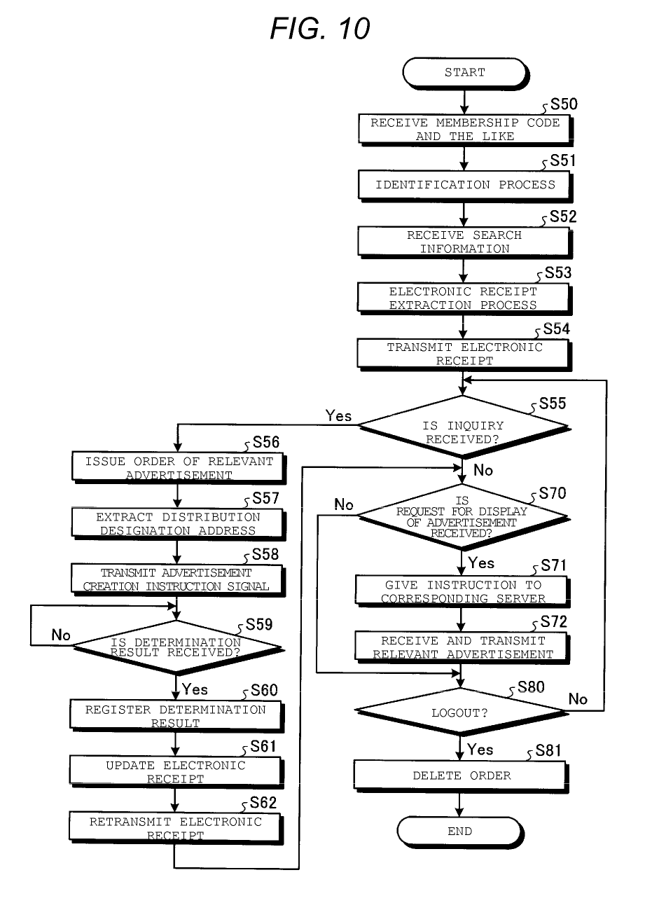

FIG. 10 is a flow chart of a distribution process in the electronic receipt management server 12. Here, although this will not be described each time below, it is assumed that when the electronic receipt management server 12 receives a processing command from the consumer terminal 15, the electronic receipt management server 12 causes a common gateway interface (CGI) to carry out the processing and receives only a processing result from the CGI. For example, when a search result is received from a database, the CGI generates a structured query language (SQL) statement and the electronic receipt management server 12 receives a result, extracted from the database, from the CGI.

When the electronic receipt management server 12 is first accessed by the consumer terminal 15 and establishes communication, the electronic receipt management server 12 receives a membership code and a password from the consumer terminal 15 (S50). Next, a personal identification process is performed by collating the membership code and the password with a membership code issued when membership registration of a consumer (in this case, a member) has been performed (S51). When the member is authenticated, the consumer terminal 15 is notified of the authentication, and the electronic receipt management server 12 receives search information of an electronic receipt from the consumer terminal 15 (S52).

Subsequently, the electronic receipt management server 12 searches the electronic receipt management table Tb40 using the search information received from the consumer terminal 15 as a key, and performs a process of extracting the corresponding electronic receipts (S53). In the processes of step S52 and step S53, for example, a consumer inputs a store name, a merchandise transaction date and time, and the like, as the search information, through the consumer terminal 15. The consumer presses a button for acquiring an electronic receipt, and thus a request for the electronic receipt and the search information are transmitted to the electronic receipt management server 12. When the electronic receipt management server 12 receives the search information together with the request, the electronic receipt management server 12 extracts the corresponding electronic receipts from the electronic receipt management table Tb40 using the search information as a search key.

Subsequently, the electronic receipt management server transmits the electronic receipts extracted from the electronic receipt management table Tb40 to the consumer terminal 15 (S54). If a new acquisition request and a new search information are received from the consumer terminal 15 before the next step S55, the flow returns to the process of step S52 to perform steps S52-S54 again. Here, it is assumed that the new acquisition request and the new search information are not received from the consumer terminal 15.

After step S54 is performed, it is determined whether or not an inquiry for relevant information is received from the consumer terminal 15 (S55). When the determination result in step S55 is “No” indicating that the inquiry for relevant information has not been received, it is subsequently determined whether or not a request for advertisement display (also referred to as the acquisition of a relevant advertisement) has been received from the consumer terminal 15 (S70).

When the determination result in the process of step S70 is “No” indicating that the request signal for advertisement display has not been received, it is subsequently determined whether or not a signal indicating that the logout is selected at the consumer terminal 15 has been received (S80). When the determination result in step S80 is “No” indicating that the signal for logout has not been received, the flow returns to step S55 to similarly repeat step S55. On the other hand, when the determination result in step S80 is “Yes”, order information (described below) of the process is deleted (S81) if the order information is present in the distribution work table Tb50, and then this process is terminated.

Meanwhile, when the determination result in step S55 is “Yes” indicating that the inquiry request signal for relevant information has been received, order information indicating that the consumer terminal 15 inquires the presence or absence of relevant information is issued (S56). Specifically, when the order information is issued, one record including a “membership code”, an “electronic receipt number”, a “merchandise code”, a “consumer terminal communication address”, a “distribution destination communication address”, and a “designation button number” is registered in the distribution work table Tb50 with respect to each merchandise code included in an electronic receipt.

Here, it is assumed that a “membership code”, an “electronic receipt number”, and “merchandise codes” of all merchandise items on an electronic receipt are transmitted together with an inquiry signal when the consumer terminal 15 inquires relevant information. The transmission of these pieces of information is performed, for example, by executing script when the inquiry button is pressed in the consumer terminal 15, collecting all of the merchandise codes included in the electronic receipt in addition to the “membership code” and the “electronic receipt number”, and transmitting the inquiry including the collected information to the electronic receipt management server 12. In this case, the electronic receipt management server 12 may issue the order information using only the information included in the request signal.

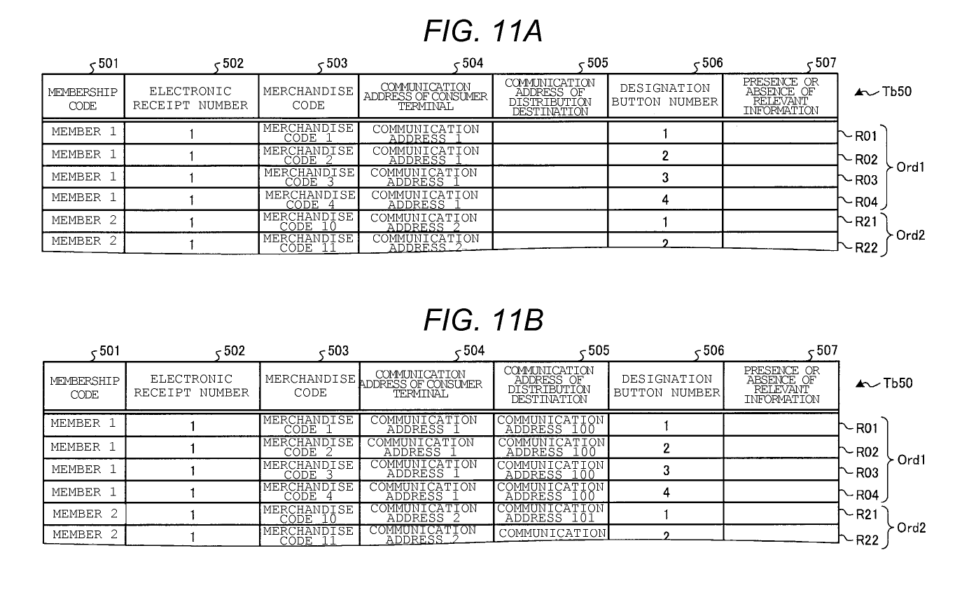

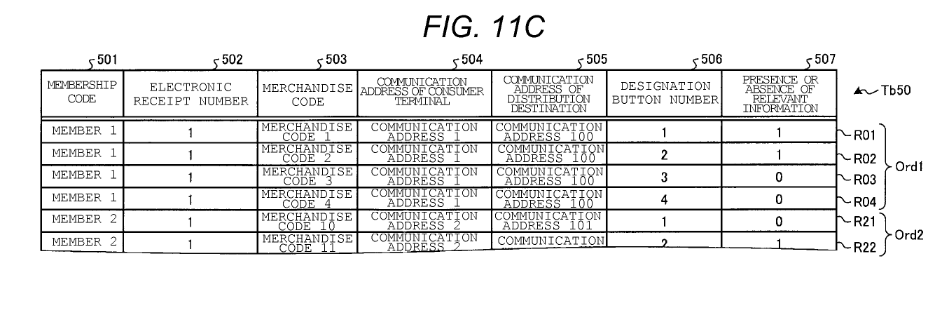

FIGS. 11A to 11C are examples of the registration of order information in the distribution work table Tb50. FIG. 11A illustrates a registration state of the work table Tb50 when two orders of “electronic receipt number “1” of “member “1”” and “electronic receipt number “1” of “member “2”” are issued.

As illustrated in FIG. 11A, one order Ord1 of electronic receipt number “1” of member “1” includes four records R01 to R04. The four records R01 to R04 correspond to four merchandise codes (merchandise codes 1-4) which are listed in the electronic receipt, respectively. Here, one order Ord2 of electronic receipt number “1” of member 2 includes two records R21 and R22. The two records R21 and R22 correspond to two merchandise codes (merchandise codes 10 and 11) which are listed in the electronic receipt.

Here, the “membership code” 501, the “electronic receipt number” 502, and the “merchandise code” 503 of the distribution work table Tb50 correspond to the above-described information (“membership code”, “electronic receipt number”, and “merchandise code”) transmitted together with the inquiry for the presence or absence of relevant information. In addition, an address of a transmission source of an inquiry request signal is registered in the “communication address of consumer terminal” 504. In addition, a serial number is generated in accordance with the number of “merchandise codes” 503, and the generated serial number is registered in the “designation button number” 506. In FIG. 11A, serial numbers “1” to “4” are given in this order to “merchandise code 1” to “merchandise code 4” corresponding to electronic receipt number “1” of member 1, respectively. In addition, serial numbers “1” and “2” are given in this order to “merchandise code 10” and “merchandise code 11” corresponding to electronic receipt number “2” of member 2.

In the present embodiment, various kinds of information included in an inquiry is transmitted from the consumer terminal 15, as information for issuing the order. In other words, the information includes the “membership code”, the “electronic receipt number”, and the “merchandise codes” of all of the merchandise items listed in the electronic receipt. However, other configurations may also be applicable. For example, when the electronic receipt management server 12 registers an electronic receipt registered from the headquarter server 11 in the electronic receipt management table Tb40, details of the electronic receipt are analyzed. Then, a “membership code” and a “merchandise code” are acquired through the analysis, and an “electronic receipt number” is generated, and the codes and the number may be correlated with the electronic receipt management table Tb40. At this time, a “designation button” is given a serial number, and may be registered in the electronic receipt management table Tb40. Thereby, information for issuing one order may not need to be transmitted from the consumer terminal 15.

Here, the description will return to the flow chart of FIG. 10, and the subsequence will be described. Subsequent to step S56, a communication address of a distribution destination is extracted from the distribution destination designation table Tb41 (S57). In step S57, a communication address of a distribution destination is extracted from the distribution destination designation table Tb41 by using one or a plurality of merchandise codes extracted from one electronic receipt one by one as keys.

FIG. 11B illustrates a state where a communication address of a distribution destination is set in the distribution work table Tb50.

In this example, URL (here, shown by “communication address 1” for convenience of description) having the same address are set in all of the merchandise codes of electronic receipt number “1” of member 1. In addition, “communication address 2” is set in all of the merchandise codes of electronic receipt number “1” of member 2. In this example, a company dealing with merchandise codes 1 to 4 and a company dealing with merchandise codes 10 and 11 are different from each other. For this reason, a communication address of a headquarter server of each company is set as the communication address. In the present embodiment, for convenience of description, all merchandise codes on one electronic receipt are associated with one company, but the exemplary embodiment is not limited thereto. One of the merchandise codes on one electronic receipt may be associated with a company A, and the other one may be associated with a company B.

The description will return to the flow chart of FIG. 10, and the subsequence will be described. Subsequent to step S57, an advertisement creation instruction signal is transmitted to servers (the headquarter server 11, the consumer goods maker server 14, and the like), which are distribution destinations set in the “communication address of distribution destination” 505 of the work table Tb50 (S58). Meanwhile, when the distribution destination is the consumer goods maker server 14, the advertisement creation instruction signal is not transmitted in this step and goes to step S60.

Thereafter, it is determined whether or not information indicating a determination result has been received from a server, which is a distribution destination (S59). When the determination result in step S59 is “No” indicating that information indicating a determination result has not been received, the flow stands by until the determination result is received.

When the determination result in step S59 is “Yes” indicating that information indicating a determination result has been received, the determination result is registered in the work table Tb50 (S60). The processes of step S59 and step S60 are repeatedly performed until the determination results with respect to all merchandise codes in one order are registered.

In other words, if distribution destinations are different from each other in one order, the processes are repeatedly performed until the determination results from each distribution destination are registered.

FIG. 11C illustrates a state where a determination result from a server which is a distribution destination is set in the “presence or absence of relevant information” 507 of the distribution work table Tb50.

In FIG. 11C, “1” indicating the presence of relevant information is set in the “presence or absence of relevant information” 507 with respect to merchandise codes 1 and 2 of electronic receipt number “1” of member 1. In addition, “0” indicating the absence of relevant information is set in the “presence or absence of relevant information” 507 with respect to merchandise codes 3 and 4. In addition, “Null” (shown as a blank in FIG. 11C) indicating that a determination result has not been received yet is set with respect to merchandise codes 10 and 11 of electronic receipt number “1” of member 2.

Meanwhile, when the distribution destination is the consumer goods maker server 14, “1” is set in the “presence or absence of relevant information” 507.

The description will return to the flow chart of FIG. 10, and the subsequent steps will be described. Subsequent to step S60, a process of updating an electronic receipt is performed (S61).

In the process of updating an electronic receipt at step S61, an electronic receipt, for which the registration of the determination result has been completed, of one order is extracted from the electronic receipt management table Tb40. Further, the setting of a designation button of a relevant advertisement to be displayed at a position of each merchandise code in an electronic receipt is updated in accordance with information of “1” indicating the presence of relevant information or “0” indicating the absence of relevant information, which is set in the “presence or absence of relevant information” 507 of the work table Tb50. Specifically, the image file of a tag on the electronic receipt is changed with respect to a designation button having “1” as the value of the “presence or absence of relevant information” 507. Accordingly, in this example, a file name is changed from the inoperable gray button to the operable white button. In addition, an execution command is associated with the designation button. The execution command is, for example, a command for requesting a relevant advertisement of the corresponding merchandise code to the electronic receipt management server 12, and such an execution command is embedded as a script on the server side.

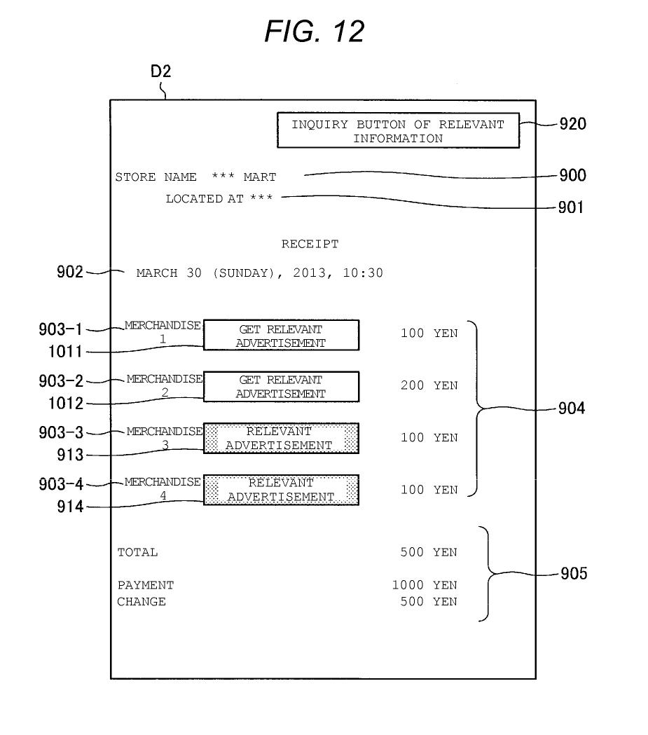

FIG. 12 illustrates an electronic receipt D2 which is updated. As illustrated in FIG. 12, designation buttons 911 and 912 of FIG. 9 are changed to designation buttons 1011 and 1012 (shown by “presence of relevant advertisement” in a white base in this example) which indicate that designation may be performed. In this state, when the designation buttons 1011 and 1012 are pressed in the consumer terminal 15, a display request signal requesting a relevant advertisement of the corresponding merchandise code is issued to the electronic receipt management server 12.

The description will return to the flow chart of FIG. 10, and the subsequent steps will be described. After the updating process of step S61, the updated electronic receipt is transmitted to the consumer terminal 15 (S62). In this process, the updated electronic receipt is transmitted toward the corresponding consumer terminal 15 with reference to the “consumer terminal communication address” of the work table Tb50.

After step S62, the flow proceeds to step S70. When “presence of relevant advertisement”, in other words, any of the designation buttons capable of performing designation is pressed in the consumer terminal 15 and a display request signal is transmitted, the electronic receipt management server 12 receives the display request signal. Then, if the determination result in the process of step S70 is “Yes” indicating that the display request signal has been received, an advertisement creation instruction signal is transmitted to a server corresponding to the designation button, in order to acquire a relevant advertisement associated with the designation button (S71). Specifically, first, the “communication address of consumer terminal” 504 and the “designation button number” 506 of the work table Tb50 are designated as search keys. Then, records corresponding to the “communication address of consumer terminal” 504 as transmission source information and the “designation button number” 506 as data, which are included in the display request signal, are extracted from the work table Tb50. Further, an advertisement creation instruction signal with respect to the “merchandise code” included in the record is transmitted toward the server of the “communication address of distribution destination” 505 included in the record.

After step S71, relevant advertisement is received from the server of the distribution destination, and the relevant advertisement is transmitted to the consumer terminal 15, which originated the request, based on the work table Tb50 (S72). When the server, which is a distribution destination, is the consumer goods maker server 14, a received banner advertisement is transmitted to the consumer terminal 15 in correlation with a predetermined position of the electronic receipt.

Here, the above-described processes are processes performed in response to one order issued from the consumer terminal 15. When a plurality of orders is generated from a plurality of consumer terminals 15, the above-described processes are performed in parallel with respect to each order. At this time, individual programs executed in order to process the orders share the work table Tb50 illustrated in FIG. 11 and execute a distribution process. Alternatively, the work table Tb50 may be generated for each consumer terminal, and an order is issued to each work table to thereby perform a distribution process.

In addition, it is preferable to set a time-out in the above-described processes. When a predetermined response is not obtained from the consumer terminal 15 or the headquarter server 11 for a certain period of time, a communication session may be cut off, and an order within the work table Tb50 corresponding to the consumer terminal 15 may also be deleted.

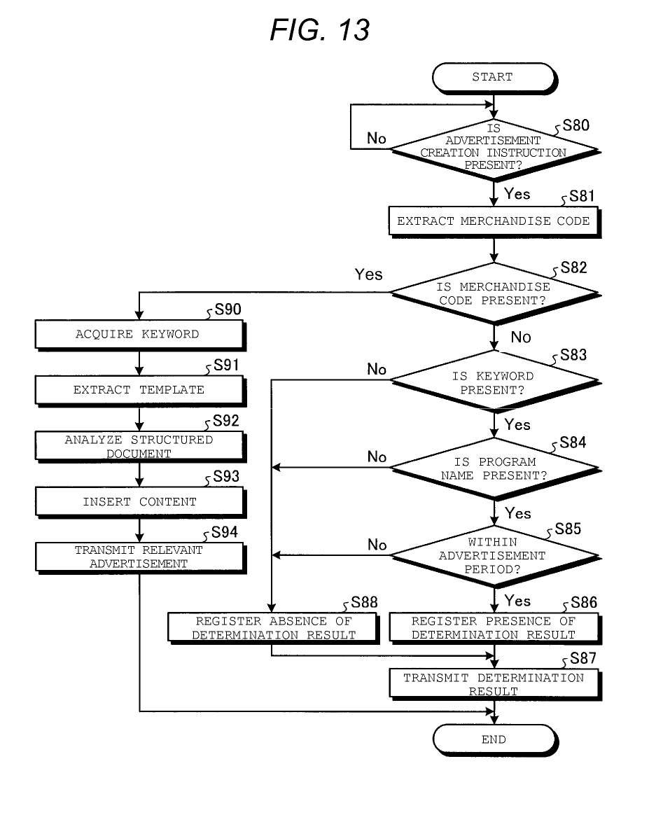

FIG. 13 is a flow chart of the processing carried out by the headquarter server 11 related to the relevant information. Here, it is assumed that when the headquarter server 11 receives a processing command from the electronic receipt management server 12, the headquarter server 11 causes a CGI to carry out the processing and receives only a processing result from the CGI. For example, when a search result is received from a database, the CGI generates an SQL statement, and the headquarter server 11 receives the search result, extracted from the database, from the CGI.

When the headquarter server 11 is first accessed by the electronic receipt management server 12 and establishes communication, it is determined whether an advertisement creation instruction signal has been received from the electronic receipt management server 12 (S80). When the determination result in the process of step S80 is “No” indicating that the advertisement creation instruction signal has not been received, the process goes into a standby state until the advertisement creation instruction signal is received.

When the determination result in the process of step S80 is “Yes” indicating that the advertisement creation instruction signal has been received, a merchandise code is extracted from the advertisement creation instruction signal (S81).

Next, the work table Tb75 is searched using the merchandise code as a key, and the presence or absence of the merchandise code is determined (S82).

When it is determined in step S82 that a merchandise code is not present, a determination process for the inquiry of the presence or absence of relevant information has not been performed yet, and thus the flow proceeds to step S83 to perform the determination process. In addition, when it is determined in step S82 that a merchandise code is present, a determination process for the inquiry of the presence or absence of relevant information has been already performed, and thus a process of automatically generating a relevant advertisement is performed.

First, a flow of the determination process for the inquiry of the presence or absence of relevant information will be described.

In step S83, the relevant table Tb70 is searched using a merchandise code as a key, a record corresponding to the merchandise code is extracted, and it is determined whether or not the record includes keywords.

When the determination result in step S83 is “Yes”, the program master table Tb71 is searched using the extracted keyword as a search key, and a record corresponding to the extracted keyword is extracted. Then, it is determined whether or not the record a program name (S84). In step S84, when the merchandise code includes a plurality of keywords, the corresponding record is extracted with respect to each keyword. Then, it is determined whether or not each record includes information indicating a program name.

When it is determined in step S84 that the program name corresponding to at least one of the keywords is included, in other words, when the determination result is “Yes”, the flow proceeds to step S85. Then, it is determined whether or not an advertisement period in the record includes the current date and time indicated by a host device (S85). In this process, for example, the current date indicated by the host device is used, and it is determined whether the current date is later than a starting date of the advertisement period and earlier than a termination date thereof, or the current date is outside the advertisement period. In step S85, when at least one keyword fit within the advertisement period, the determination result is “Yes”, and the flow proceeds to step S86.

In step S86, the determination result is registered in the work table Tb75. In the present embodiment, a merchandise code acquired from an advertisement creation instruction signal is registered in the “merchandise code” 751. In addition, keyword information and a relevant merchandise code which are included in the advertisement period and determined to be “Yes” in step S85 are registered in the “keyword” 753 and the “relevant merchandise code” 754, respectively. In addition, information of “1” indicating a determination result of the presence of relevant information is registered in the “determination result” 752.

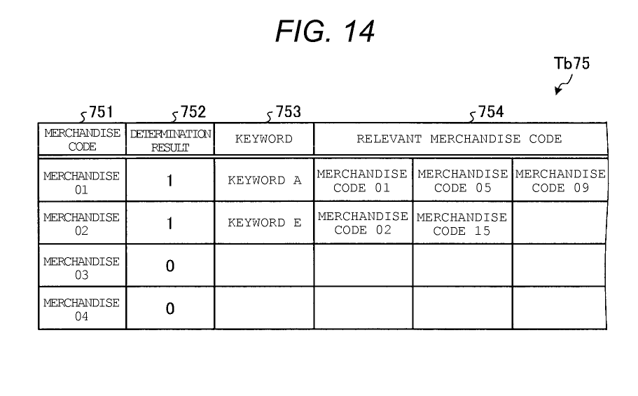

FIG. 14 illustrates an example of the setting of the work table Tb75 during which the presence or absence of relevant information is determined with respect to merchandise code 1 to merchandise code 4.

As illustrated in FIG. 14, “1” indicating the presence of relevant information is set in the “determination result” 752 with respect to merchandise 1. In addition, “keyword A”, which is narrowed into one by a determination process, is set in the “keyword” 753. In addition, merchandise code 01, merchandise code 05, and merchandise code 09, which are correlated with the keyword and the advertisement period in the program master table Tb71, are set in the “relevant merchandise code” 754 as relevant merchandise codes.

In addition, “1” indicating the presence of relevant information is set in the “determination result” 752 with respect to merchandise 2. “keyword E”, which is narrowed into one by a determination process, is set in the “keyword” 753. In addition, merchandise code 02 and merchandise code 15, not shown in the program master table Tb71 of FIG. 7, which are correlated with the keyword E and the advertisement period are set in the “relevant merchandise code” 754 as relevant merchandise codes.

On the other hand, the “determination result” 752 is set to be “0” indicating the absence of relevant information with respect to merchandise 3 and merchandise 4, and the “keyword” 753 and the “relevant merchandise code” 754 are set to be “Null (shown by blank in FIG. 14)” because the determination result is the absence of relevant information.

In this example, it is assumed that the other merchandise codes (other than merchandise codes 1 to 4) which are not subjected to the process of the determination result are not registered in the work table Tb75.

The registration once made in the work table Tb75 is deleted after a process of automatically generating a relevant advertisement. In addition, the registration once made is left for a predetermined period of time, and may be used again when the electronic receipt management server 12 inquires the same merchandise code. The standard of the predetermined period of time may be appropriately set. For example, the period of time may be set to be a few hours, one day, a few weeks, or the like, and may be set to be a period until the updating of details of a database is performed.

In the following description, in order to facilitate the understanding, it is assumed that a merchandise code is not repeatedly registered in the work table Tb75. In other words, it is assumed that one keyword corresponds to one merchandise code.

Here, the description will return to the flow chart of FIG. 13, and the subsequent process will be described.

After step S86, information (determination result information) indicating the presence of relevant information or the absence of relevant information with respect to a merchandise code is transmitted to the electronic receipt management server 12 as a response to the inquiry of relevant information (S87), and this process is terminated.

On the other hand, when the determination result in step S83 is “No” indicating that keyword information is not included, the flow proceeds to step S88.

In step S88, the merchandise code and a record including “0” indicating a determination result of the absence of relevant information are registered in the work table Tb75. In other words, the merchandise code is set in an item of the “merchandise code” 751 of the work table Tb75, and “0” indicating a determination result of the absence of relevant information is set in the corresponding item of the “determination result” 752. After step S88, step S87 is performed.

In addition, when it is determined in step S84 that a program name is not registered with respect to all of the keyword information extracted in step S83, in other words, when the determination result is “No”, the flow proceeds to step S88.

In step S85, when an advertisement period does not include the current date indicated by the host device with respect to all of the keywords extracted in step S83, the flow proceeds to step S88.

Next, a flow of a process of automatically generating a relevant advertisement will be described.

In step S90, the keyword information registered in the work table Tb75 during the process of determining the presence or absence of relevant information is acquired from the work table Tb75. In step S90, the corresponding record is extracted from the work table Tb75 using a merchandise code extracted from an advertisement creation instruction signal as a key, and the keyword information is acquired from the record.

Next, information of a template (advertisement creation template), which is used to create a relevant advertisement, is extracted (S91).

In this process, the template table Tb73 is retrieved using the keyword information acquired in step S90 as a key, and a file name (also including path information and the like) of the advertisement creation template corresponding to the keyword information is extracted.

Next, a template file on the path thereof is read out based on the information extracted in step S91, the template is analyzed, and an insertion position of a content, the attribution of a content, and the like are specified (S92).

Next, content data are extracted from the content table Tb74, other tables Tb71 and Tb72, and the like and are inserted into insertion positions of the template file (S93). In this process, records having identical merchandise codes are extracted (collected) from the tables Tb71, Tb72, and Tb74 and the like using a keyword of the record extracted in step S90 and particularly using a relevant merchandise code. Next, a content designated at the insertion position specified in step S92 is extracted from the extracted records. When the content is an image or the like other than text, a file name (also including path information and the like) is extracted. Then, the extracted information is inserted into the insertion position of the template file.

When the number of insertion positions is two or more, the corresponding contents are sequentially and repeatedly inserted in accordance with an index number, attribution, and the like which are shown in a tag, and all insertion locations of the advertisement creation template are filled.

Then, relevant advertisement formed by filling the template is transmitted to the electronic receipt management server 12 (S94). In the present embodiment, a structured document formed by filling the advertisement creation template, an image file, a movie file, a sound file, and the like are transmitted to the electronic receipt management 12 server as the relevant advertisement.

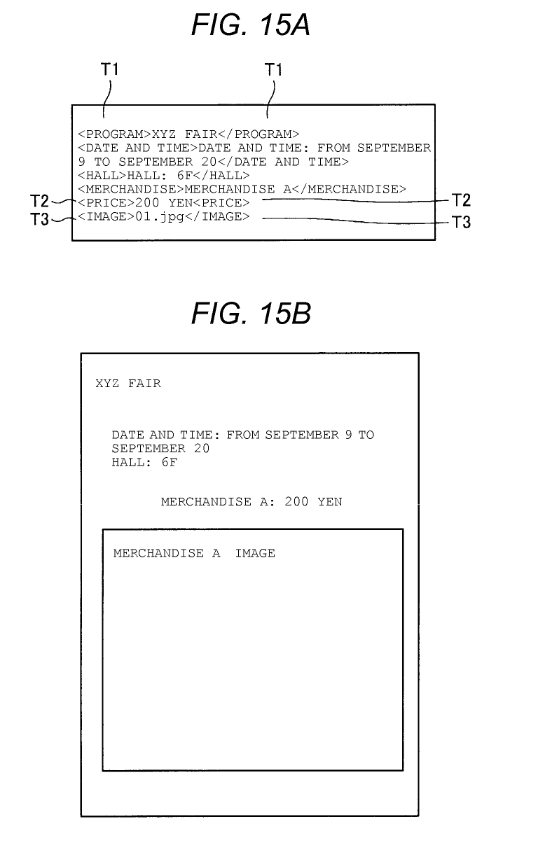

FIGS. 15A and 15B are configuration diagrams of relevant advertisement.

FIG. 15A illustrates a portion of a structured document of an advertisement template when a content is embedded into an insertion position thereof. In FIG. 15A, the types of insertion data as attribution information are described in tags, and the corresponding content is embedded into the position indicated by the type of each tag.

For example, “xyz fair” as a program name is embedded into the position of a tag T1 indicating a name of a promotion program. This indicates that “xyz fair” which is the corresponding program name is extracted from the program master table Tb71 and is embedded. In addition, “¥200” which is the price of merchandise is embedded into the position of a tag T2 indicating a price. This indicates that “¥200” which is the present price of the corresponding merchandise is extracted from the merchandise master table Tb72 and is embedded. In addition, “01.jpg” as an image file name is embedded into the position of a tag T3 indicating an image. This indicates that “01.jpg” which is the image file name of corresponding related merchandise is extracted from the content table Tb74 and is embedded.

When a plurality of merchandise codes are obtained from the work table Tb75 as related merchandise of merchandise, the above-described series of processes of acquiring and inserting data is repeatedly performed with respect to each merchandise code. The generated data is connected right after a relevant advertisement of the previous merchandise by attaching a relevant advertisement of the subsequent merchandise thereto.

In this manner, the headquarter server 11 transmits the generated data, in other words, the structured document formed by filling the template and the image file to the electronic receipt management server 12 as relevant advertisement.

In the present embodiment, content data of related merchandise is collected from the merchandise master table Tb72, the program master table Tb71, and the like in addition to the content data of the content table Tb74. However, information registered in the merchandise master table Tb72, the program master table Tb71, and the like may be sequentially or regularly copied to the content table Tb74, and content data of related merchandise may be collected from the content table Tb74.

When the electronic receipt management server 12 acquires relevant advertisement from the headquarter server 11, the acquired relevant advertisement is subjected to a conversion process and the like so as to be capable of being displayed on a browser of the consumer terminal 15 and is then transmitted to the consumer terminal 15. In this conversion process and the like, conversion into an HTML or an XHTML is performed so that reading may be performed by a browser installed in the consumer terminal 15. In addition, tag information indicating a reading destination such as an image is designated in a storage destination of the image and the like in the electronic receipt management server 12.

Here, setting of a return button for returning to an electronic receipt or a close button may be appropriately performed in the consumer terminal 15.

The relevant advertisement generated in this manner is transmitted to the consumer terminal 15, which originated the request and indicated by the work table Tb50 in the electronic receipt management server 12.

FIG. 15B is a display example when the relevant advertisement is displayed on the consumer terminal 15 based on the structured document illustrated in FIG. 15A, using the web browser. As illustrated in FIG. 15B, a content is displayed in the order illustrated in FIG. 15A. Here, it is assumed that information such as the size of a character and the size and layout of an image are designated by a separate CSS or the like.

In FIG. 15B, a relevant advertisement for promoting the program name “xyz fair” is shown as relevant advertisement.

In the relevant advertisement, the period of the program “xyz fair” and information of merchandise which is specially sold during the period are displayed by image.

The information of merchandise includes a merchandise price in addition to a merchandise name. The merchandise price is acquired from the merchandise master table Tb72 when a relevant advertisement is created, the latest information is acquired from the merchandise master table Tb72, and the latest information may be listed in the advertisement.

In the present embodiment, when there is no related merchandise, in other words, information indicating a determination result of the work table Tb75 of the headquarter server 11 is set to be “0” in spite of pressing a designation button, no relevant advertisement is generated. Accordingly, a display screen is not changed, and no advertisement is displayed.

In the present embodiment, it is assumed that the headquarter server 11 inserts a designation button and an inquiry button and the electronic receipt management server 12 changes the setting of the designation button, but the exemplary embodiment is not limited thereto. The electronic receipt management server 12 may collectively insert a designation button and an inquiry button and change the setting of the buttons.

In the present embodiment, inquiry regarding whether or not relevant information is present is performed in a first step with respect to a specific server managing merchandise, and then the display of a relevant advertisement is designated, but the exemplary embodiment is not limited thereto.

As a modified example of the present embodiment, a designation button on an electronic receipt may be selectable in advance. When the designation button is selected in the consumer terminal 15, the electronic receipt management server 12 may distribute and transmit an advertisement creation instruction signal to the headquarter server 11 managing the merchandise corresponding to the designation button, and the headquarter server 11 may automatically generate relevant advertisement without determining the presence or absence of relevant information and may transmit the generated relevant advertisement to the consumer terminal 15 through the electronic receipt management server 12. In this case, the headquarter server 11 may not include the determination section 112. In addition, when there is no relevant information, it is not possible to transmit relevant advertisement. Accordingly, when relevant advertisement is not transmitted after a certain period of time, the electronic receipt management server 12 may assume that there is no relevant advertisement.

In addition, the electronic receipt management server 12 may prepare a company's banner advertisement in advance, adds the banner advertisement to an electronic receipt, and transmits the electronic receipt having the banner advertisement added thereto to the consumer terminal 15.

In the present embodiment, merchandise information is dealt with. However, the exemplary embodiment is not limited to merchandise, and provision for labor such as a service may be performed.

In the present embodiment, such a server device is applied to a headquarter server in the electronic receipt system that distributes an electronic receipt to the consumer terminal 15, but the exemplary embodiment is not limited thereto. Such a server device may be applied to a store server or other server devices.

As described above, a search engine server includes a database including a first table in which each of one or more merchandise codes is associated with one or more keywords and a second table in which each of one or more promotional programs is associated with one or more keywords and a time period, a communication unit that receives a command including a merchandise code from a mobile device, and a control unit. The control unit is configured to access the first table to retrieve one or more keywords associated with the received merchandise code, search the second table for one or more promotional programs associated with the retrieved keywords, and extract one or more promotional programs of which time period includes a current time. When at least one promotional program is extracted, the communication unit transmits a response indicating that the merchandise code in the command is associated with a promotional program.

Thereby, it is possible to display an advertisement associated with merchandise or a service which is transacted by a customer, on an electronic receipt.

Various programs used in a server device of the present embodiment may be provided by being recorded in a computer-readable recording medium such as a CD-ROM, a flexible disk (FD), a CD-R, or a digital versatile disk (DVD) as files in an installable format or an executable format, and may be executed by being read by a flash ROM or the like of the server device.

Alternatively, the programs may be provided by being stored in a computer connected to a network such as the Internet and being downloaded through the network.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

What is claimed is:

1. A search engine server, comprising:
a storage unit storing a database including a first table in which each of one or more merchandise codes is associated with one or more keywords, and a second table in which each of one or more promotional programs is associated with one or more keywords and a time period;
a communication unit configured to receive a command including a merchandise code originated by a computing device of a user; and
a control unit configured to
access the first table to retrieve one or more keywords associated with the merchandise code included in the command,
search the second table for one or more promotional programs associated with the retrieved keywords, and
extract one or more promotional programs having an effective time period that includes a current time, from the searched result, wherein
when at least one promotional program is extracted, the communication unit transmits a response indicating that the merchandise code in the command is associated with a promotional program.

2. The server according to claim 1, wherein
the database further includes a third table that associates one or more merchandise codes with one or more keywords.

3. The server according to claim 2, wherein
in the third table, a flag field is set for the merchandise code associated with promotional programs.

4. The server according to claim 2, wherein
the database further includes a fourth table in which each of one or more keywords is associated with template data,
the communication unit is further configured to receive a secondary command including the merchandise code included in the command, and
the control unit is further configured to
access the third table to retrieve the keyword associated with the merchandise code included in the secondary command,
search the fourth table to obtain template data associated with the keyword retrieved from the third table, and
generate image data related to a promotional program using the obtained template data.

5. The server according to claim 4, wherein
the communication unit is further configured to transmit the generated image data, such that an image of the image data is displayed on the computing device.

6. The server according to claim 5, wherein
the generated image data is transmitted to the computing device through a secondary sever.

7. The server according to claim 4, wherein
the database further includes a fifth table in which each of one or more merchandise codes is associated with an insert image,
the control unit is further configured to search the fifth table to obtain an insert image associated with the merchandise code included in the secondary command, and
the image data containing the obtained insert image is generated.

8. The server according to claim 1, wherein
the response is transmitted to the computing device through a secondary server.

9. A method of searching data relevant to search criteria included in an electronic record transmitted from a computing device, comprising:
receiving a command including a merchandise code originated by a computing device of a user;
accessing a first table of a database in which each of one or more merchandise code is associated with one or more keywords, to retrieve one or more keywords associated with the merchandise code included in the command;
searching a second table of the database in which each of one or more promotional programs is associated with one or more keywords, for one or more promotional programs associated with the retrieved keywords;
extracting one or more promotional programs having an effective time period that includes a current time, from the searched results; and
when at least one promotional program is extracted, transmitting a response indicating that the merchandise code in the command is associated with a promotional program.

10. The method according to claim 9, further comprising:
when at least one promotional program is extracted, registering, in a third table of the database, the merchandise code in the command and the one or more keywords associated therewith.

11. The method according to claim 10, further comprising:
setting a flag field in the third table with respect to the registered merchandise code.

12. The method according to claim 10, further comprising:
receiving a secondary command including the merchandise code included in the command;
accessing the third table to retrieve the keyword associated with the merchandise code included in the second command;
searching a fourth table, in which each of one or more keywords is associated with template data, to obtain template data associated with the keyword retrieved from the third table; and
generating image data related to a promotional program using the searched template data.

13. The method according to claim 12, further comprising:
transmitting the generated image data, such that an image of the image data is displayed on the computing device.

14. The method according to claim 13, wherein
the generated image data is transmitted to the computing device through a secondary sever.

15. The method according to claim 12, further comprising:
searching a fifth table, in which each of one or more merchandise codes is associated with an insert image, to obtain an insert image associated with the merchandise code included in the secondary command, wherein
the image data containing the obtained insert image is generated.

16. The method according to claim 9, further comprising:
the response is transmitted to the computing device through a secondary server.

17. A search engine server, comprising:
a storage unit storing a database including a first table in which each of one or more merchandise codes that is targeted for a promotional program is associated with a keyword and a second table in which each of one or more keywords is associated with template data;
a communication unit configured to receive a command including a merchandise code originated by a computing device of a user; and
a control unit configured to
access the first table to retrieve the keyword associated with the merchandise code included in the command,
search the second table to obtain template data associated with the retrieved keyword, and
generate image data related to a promotional program using the obtained template data.

18. The sever according to claim 17, wherein
the communication unit is further configured to transmit the generated image data, such that an image of the image data is displayed on the computing device.

19. The sever according to claim 18, wherein
the generated image data is transmitted to the computing device through a secondary sever.

20. The sever according to claim 17, wherein
the database further includes a third table in which each of one or more merchandise codes is associated with an insert image,
the control unit is further configured to search the third table to obtain an insert image associated with the merchandise code included in the command, and
the image data containing the obtained insert image is generated.
